(19) United States
(12) Patent Application Publication
(10) Pub. No.: US 2024/0348027 A1
(43) Pub. Date: Oct. 17, 2024

(54) CORRUGATED TUBE PROTECTION MEMBER

(71) Applicant: Yazaki Corporation, Tokyo (JP)

(72) Inventor: Youngho JANG, Aichi (JP)

(73) Assignee: Yazaki Corporation, Tokyo (JP)

(21) Appl. No.: 18/632,507

(22) Filed: Apr. 11, 2024

(30) Foreign Application Priority Data
Apr. 17, 2023 (JP) 2023-067057

(51) Int. Cl. H02G 3/04; H01B 7/00

(52) U.S. Cl. CPC H02G 3/0468; H01B 7/0045

(57) ABSTRACT

Provided is a corrugated tube protection member disposed at an inner periphery of a corrugated tube, the corrugated tube protection member including: a body part formed into a cylindrical shape in which a wire harness is inserted and arranged, in which the body part is constituted by a pair of divided members divided along a length direction of the wire harness, and the pair of divided members are connected to each other by a hinge disposed at a circumferential end edge and a leaf spring disposed so as to span the hinge, and can be opened and closed via the hinge and the leaf spring.

### CROSS-REFERENCE TO RELATED APPLICATIONS

The present application is based on, and claims priority from the prior Japanese Patent Application No. 2023-067057, filed on Apr. 17, 2023, the entire contents of which are incorporated herein by reference.

### TECHNICAL FIELD

The present disclosure relates to a corrugated tube protection member.

### BACKGROUND

Conventionally, a corrugated tube is widely used as a member for protecting a wire harness while being flexible. As a protection member for preventing an end of the corrugated tube from being collapsed, there is known a protection member which is arranged at the inner periphery of the end of the corrugated tube and has a cylindrical part as a cylindrical body part into which the wire harness is inserted.

The corrugated tube protection member is constituted by a pair of divided members, the wire harness is arranged in the cylindrical part while the cylindrical part is divided in a circumferential direction, and the wire harness is inserted into the cylindrical part by closing the divided members. JP 2019-75946 A discloses a corrugated tube protection member having a lock structure in which a coupling concave part and a coupling convex part are disposed at end edges of a pair of divided members, and while division surfaces facing each other in a circumferential direction are aligned, the coupling concave part and the coupling convex part are engaged.

### SUMMARY OF THE INVENTION

However, in JP 2019-75946 A, when the corrugated tube protection member is mounted to a wire harness, it is necessary to manually engage the coupling concave part with the coupling convex part while maintaining a state in which the wire harness is arranged in the opened protection member, and therefore the mounting workability is degraded.

The present disclosure has been devised in view of the problem of a prior art. An object of the present disclosure is to provide a corrugated tube protection member with the enhanced mounting workability by simplifying an operation of mounting the corrugated tube protection member to a wire harness.

An aspect of the present disclosure provides a corrugated tube protection member disposed at an inner periphery of a corrugated tube, the corrugated tube protection member including: a body part formed into a cylindrical shape in which a wire harness is inserted and arranged, in which the body part is constituted by a pair of divided members divided along a length direction of the wire harness, and the pair of divided members are connected to each other by a hinge disposed at a circumferential end edge and a leaf spring disposed so as to span the hinge, and can be opened and closed via the hinge and the leaf spring.

According to the present disclosure, it is possible to provide a corrugated tube protection member with the enhanced mounting workability by simplifying an operation of mounting the corrugated tube protection member to a wire harness.

### BRIEF DESCRIPTION OF DRAWINGS

FIG. 1 is a perspective view illustrating a state in which a pair of divided members of a corrugated tube protection member according to the present embodiment are opened.

FIG. 2 is a front view illustrating a state in which a pair of divided members are opened before the corrugated tube protection member according to the present embodiment is mounted to a wire harness.

FIG. 3 is a front view illustrating a state in which a pair of divided members are closed after the corrugated tube protection member according to the present embodiment is mounted to the wire harness.

### DETAILED DESCRIPTION OF THE INVENTION

A corrugated tube protection member according to the present embodiment will be described in detail below with reference to the drawings. The dimensional ratios of the drawings are exaggerated for convenience of explanation and may differ from the actual ratio.

A corrugated tube protection member 1 according to the present embodiment is disposed at the inner periphery of a corrugated tube (not illustrated). The corrugated tube is flexible, a wire harness for electrically connecting a power source, a device, and the like mounted in a vehicle are inserted into the corrugated tube, and the corrugated tube prevents interference between the wire harness and a peripheral member, for example. When the corrugated tube receives an external force from the outside in a radial direction, there is a possibility that the corrugated tube is deformed so as to collapse toward the inside. In particular, if deformation occurs at an end of the corrugated tube, there is a possibility that the corrugated tube cannot be mounted to a mounting member such as a protector to which the wire harness is wired. Therefore, the corrugated tube protection member 1 is disposed at the inner periphery of the corrugated tube.

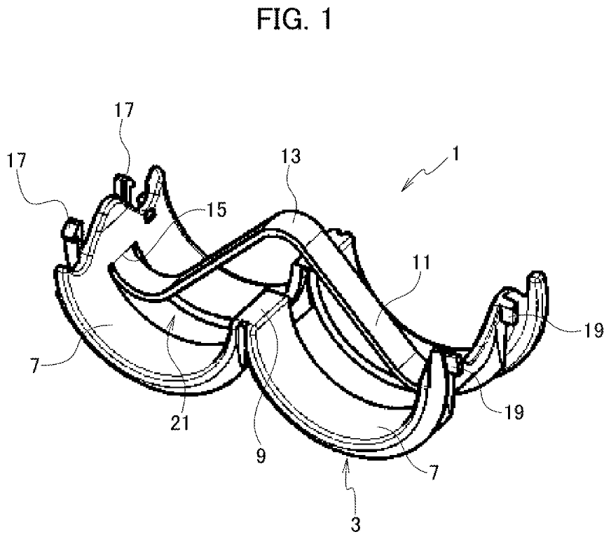

As illustrated in FIGS. 1 to 3, the corrugated tube protection member 1 according to the present embodiment includes a body part 3. The body part 3 is formed into a cylindrical shape having an outer diameter smaller than an inner diameter of the corrugated tube so as to be able to be inserted into the corrugated tube. In addition, the body part 3 is formed into a cylindrical shape extended along a length direction of the wire harness 5 such that the wire harness 5 is inserted into and arranged in the body part. The body part 3 is constituted by a pair of divided members 7 and 7 divided along a length direction at two facing locations.

An end edge of one of the two division locations of the pair of divided members 7 and 7 and an end edge of the other of the two division locations are connected by means of a hinges 9. The hinge 9 is continuously formed along a length direction of the wire harness 5, and the pair of divided members 7 and 7 can be opened and closed by means of the hinge 9. In this way, due to the body part 3 being constituted by the pair of divided members 7 and 7 that can be opened and closed, the wire harness 5 can be arranged inside the corrugated tube protection member 1 without using a jig to open a slit in the body part 3 formed to have a cylindrical shape. Further, due to the body part 3 being constituted by the pair of divided members 7 and 7 which can be opened and closed, even in a state where the wire harness 5 is wired in a vehicle, the corrugated tube protection member 1 can be mounted to a middle portion of the wire harness 5

The pair of divided members 7 and 7 are connected by a single leaf spring 11 made of an elastic member. As illustrated in FIGS. 1 and 2, the leaf spring 11 is formed into a plane symmetrical shape so as to span the hinge 9.

The leaf spring 11 has a curved top part 13 in a center portion and two branch parts 15 at both ends. The leaf spring 11 is integrally formed with the body part 3 (the pair of divided members 7 and 7). Each branch part 15 is connected to each divided member 7 at an approximately central portion of each divided member 7 in the length direction, that is, at the vicinity of an end edge opposite to an end edge connected to the hinge 9 of each divided member 7. Further, as illustrated in FIG. 2, the top part 13 and a portion toward each branch part 15 are formed into an approximately arc shape, and a portion between the top part 13 and each branch part 15 is approximately linear.

As illustrated in FIG. 2, when the pair of divided members 7 and 7 are opened, the top part 13 protrudes in a direction away from the hinge 9, and is located at a position most distant from the hinge 9 (upper portion in FIG. 2). As will be described later, due to the top part 13 being pushed by the wire harness 5 in a direction opposite to the direction in which the top part 13 protrudes (down arrow direction in FIG. 2), the pair of divided members 7 and 7 close while taking the wire harness 5 therein. The wire harness 5 is inserted into and arranged in the corrugated tube protection member 1.

In this way, the pair of divided members 7 and 7 are connected to each other by means of the hinge 9 disposed at circumferential end edges and the leaf spring 11 disposed so as to span the hinge 9.

It is preferable that protruding lock parts 17 having locking claws are disposed at an end edge of one of the divided members 7 opposite to the hinge 9. It is preferable that protruding locked parts 19 are disposed at an end edge of the other of the divided members 7 opposite to the hinge 9, the locked parts 19 being able to engage with the lock parts 17 when the pair of divided members 7 and 7 are closed. In FIG. 1, although the number of lock parts 17 is two and the number of locked parts 19 is also two, there is no particular limitation on the number as long as the number of lock parts 17 and the number of locked parts 19 are the same, and the number both lock parts 17 and locked parts 19 may be one or three or more.

When the number of lock parts 17 at the end edge of one of the divided members 7 is more than one and the number of locked parts 19 at the end edge of the other of the divided members 7 is also more than one, it is preferable that the lock parts 17 and the locked parts 19 are arranged in line in a length direction of the wire harness 5. Further, the arrangement of the lock parts 17 and the arrangement of the locked parts 19 may be interchanged, or for example, the parts may be arranged in a staggered manner such that a lock part 17 and a locked part 19 are arranged at the end edge of one of the divided members 7, and a locked part 19 and a lock part 17 are arranged at the end edge of the other of the divided members 7.

The lock parts 17 and the locked parts 19 engage when the pair of divided members 7 and 7 are in a closed state. Even if the wire harness 5 is bent and the body part 3 is bent, due to the engagement between the lock parts 17 and the locked parts 19, the opening of the body part 3 is prevented and the wire harness 5 is not exposed. Therefore, it is not necessary to perform processing requiring a skilled technique such as a tape winding on the outer periphery of the body part 3.

The corrugated tube protection member 1 can be prepared by performing integrally molding with resin, for example. When integrally molding is performed, a mold is used which is in accordance with a shape in which the pair of divided members 7 and 7 are opened.

When the corrugated tube protection member 1 is prepared, the body part 3 and leaf spring 11 may be made of the same resin, a combination of different resin, or a combination of different materials. It is possible to prepare the corrugated tube protection member 1 by mounting the leaf spring 11 constituted by a metal piece to the body part 3 made of resin, for example.

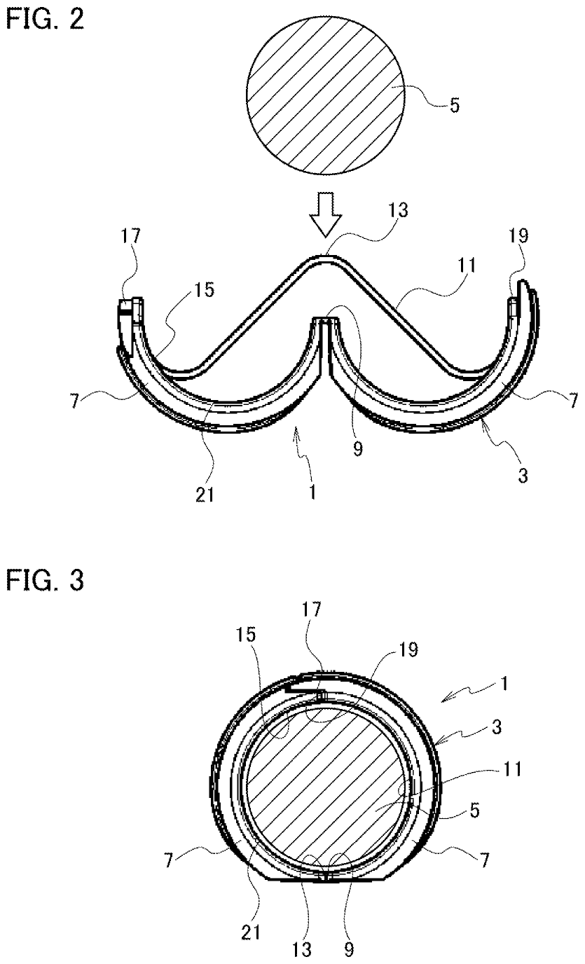

In a method of mounting the wire harness 5 to the corrugated tube protection member 1, as illustrated in FIG. 2, first, the pair of opened divided members 7 and 7 are arranged to the wire harness 5. Next, a side surface of the wire harness 5 is pushed against the top part 13 of the leaf spring 11 in the direction opposite to the direction in which the top part 13 protrudes (down arrow direction in FIG. 2), and therefore the leaf spring 11 is bent so as to warp downward. The leaf spring 11 warped downward is deformed into a shape along inner peripheral surfaces of the pair of divided members 7 and 7, and due to the reaction, the pair of divided members 7 and 7 of the corrugated tube protection member 1 are closed while taking the wire harness 5 therein. Finally, as illustrated in FIG. 3, due to the engagement between the lock parts 17 and the locked parts 19, the pair of divided members 7 and 7 are closed, and the wire harness 5 is inserted into and arranged in the corrugated tube protection member 1. In this way, when the corrugated tube protection member 1 is mounted to the wire harness 5, it is sufficient if the wire harness 5 is pushed against the top part 13 of the leaf spring 11. Accordingly, as in the past, it is not necessary to manually perform a series of operations of engaging a lock structure of the corrugated tube protection member while maintaining a state in which a wire harness is arranged in an opened corrugated tube protection member, and the mounting workability can be enhanced.

It is preferable that the pair of divided members 7 and 7 have a groove part 21 which can house the leaf spring 11 when the members are closed. As illustrated in FIG. 1, the groove part 21 is formed in the inner peripheral surfaces of the pair of divided members 7 and 7 and has a size slightly larger than the width, length, and thickness of the leaf spring. Therefore, when the pair of divided members 7 and 7 are closed, the groove part can house the entire leaf spring 11 in accordance with a shape along the inner peripheral surfaces of the pair of divided members 7 and 7. Due to the members having the groove part 21, when the wire harness 5 is inserted into and arranged in the corrugated tube protection member 1, a clearance between the corrugated tube protection member 1 and the wire harness 5 becomes small. Therefore, a state in which the wire harness 5 is arranged in the corrugated tube protection member 1 can be stably maintained.

In a method of removing the wire harness 5 from the corrugated tube protection member 1, first, the engagement between the lock parts 17 and the locked parts 19 in the state shown in FIG. 3 is released, and the pair of divided members 7 and 7 are opened. The top part 13 of the leaf spring 11 is returned to protrude upward as illustrated in FIG. 2, and therefore the wire harness 5 can be easily removed.

The corrugated tube protection member 1 is arranged at the inner periphery of the corrugated tube, and has the cylindrical body part in which the wire harness 5 is inserted and arranged. The body part 3 is constituted by the pair of divided members 7 and 7 divided along the length direction of the wire harness 5. Further, the pair of divided members 7 and 7 are connected to each other by means of the hinge 9 disposed at the circumferential end edges and the leaf spring 11 disposed so as to span the hinge 9, and can be opened and closed via the hinge 9 and the leaf spring 11. When the corrugated tube protection member 1 is mounted to the wire harness 5, it is sufficient if the wire harness 5 is pushed against the top part 13 of the leaf spring 11. Therefore, an operation of mounting the corrugated tube protection member 1 to the wire harness can be simplified and the mounting workability can be enhanced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A corrugated tube protection member disposed at an inner periphery of a corrugated tube, the corrugated tube protection member comprising:
a body part formed into a cylindrical shape in which a wire harness is inserted and arranged, wherein
the body part is constituted by a pair of divided members divided along a length direction of the wire harness, and
the pair of divided members are connected to each other by a hinge disposed at a circumferential end edge and a leaf spring disposed so as to span the hinge, and can be opened and closed via the hinge and the leaf spring.

2. The corrugated tube protection member according to claim 1, wherein
when the pair of divided members are opened, a top part of the leaf spring protrudes in a direction away from the hinge and
when the pair of divided members are closed, the leaf spring is in accordance with a shape along an inner peripheral surface of the divided members.

3. The corrugated tube protection member according to claim 1, wherein
the pair of divided members include a lock part and a locked part that can engage with the lock part when the pair of divided members are closed.

4. The corrugated tube protection member according to claim 1, wherein
the pair of divided members include a groove part that can house the leaf spring when the pair of divided members are closed.
